(19) United States
(12) Patent Application Publication
(10) Pub. No.: US 2015/0241174 A1
(43) Pub. Date: Aug. 27, 2015

(54) SUPPORT FOR MOUNTING AN ACCESSORY TO A WEAPON

(71) Applicant: MASINA-TUOTE OY, Puuppola (FI)

(72) Inventor: Martti Silvennoinen, Puuppola (FI)

(21) Appl. No.: 14/631,164

(22) Filed: Feb. 25, 2015

(30) Foreign Application Priority Data
Feb. 27, 2014 (FI) 20145190

(51) Int. Cl. F41G 11/00; F16B 2/12

(52) U.S. Cl. CPC F41G 11/004; F16B 2/12

(57) ABSTRACT

The invention relates to a support for mounting an accessory to a weapon. The support includes a bracket and a locking piece fitted in the bracket. The support further includes spring elements, arranged to act on the locking piece, the work direction (W) of the elements being parallel to the locking direction (L) of the locking piece arranged in the bracket.

### TECHNICAL FIELD

This invention relates to a support for mounting an accessory to a weapon, the support including a bracket and a locking piece fitted to the bracket.

### BACKGROUND OF THE INVENTION

Various weapons, particularly rifles, are used for different purposes. The selection of a weapon is influenced, for example, by the game animal to be shot and the hunting conditions. Weapons are also used in competitions, such as so-called practical shooting. Particularly sighting devices, such as sniperscopes, exist for various purposes. Thus, when shooting different game animals, one person often has several weapons, which have different sighting devices for different game animals. Sniperscopes, in particular, are expensive and susceptible to damage, such as dents, during storage and transportation. The alignment of sighting devices relative to the weapon may also change. In this case, the accuracy of the weapon deteriorates after the sighting device has been installed.

Today, a so-called Picatinny™ rail, the official name of which is MIL-STD-1913, is often used for mounting accessories to a weapon. Accessories include sniperscopes, tactical lights and laser aiming devices. Torches, additional handles and grips, front legs, bayonets and red dot sights can also be mounted as accessories. The length of the rails is selected as needed and they are mounted to the different parts of the frame of the weapon, such as to the sides or under the barrel. For example, a sniperscope usually includes two supports both equipped with a bracket. Each bracket is fastened to the rail with a locking piece included in the bracket.

The support can be a part of the accessory. The bracket included in the support is slid onto the rail from either end. Alternatively, the bracket is placed directly around the rail with the locking piece in the released state. After the setup, the locking pieces of the bracket are tightened in place as firmly as possible using bolts, screws or latches.

In prior art brackets, the position of the locking piece relative to the bracket is unstable. Thus, the mounting of the bracket is unreliable. Correspondingly, different mounting devices of the bracket include several different components, which makes the design of a prior art bracket complicated. In addition, the removal and mounting of the bracket is time-consuming and generally requires tools. The bracket and particularly the mounting devices also include protruding parts, which increase the risk of damage and accidents and can lead to an inadvertent release of the locking piece from the locked position. In this case, the accessory together with the bracket can detach from the weapon. Sighting devices in particular are sensitive. Thus, even a small clearance or a change in the bracket position spoils the accuracy of the weapon.

### SUMMARY OF THE INVENTION

The object of the invention is to provide a novel support for mounting an accessory to a weapon, the support having a simpler and more compact design than before and enabling easier and quicker release and mounting than heretofore. The characteristic features of this invention become apparent from the appended claims. The support can be quickly used with one grip without tools. Thus, the accessory can be mounted and released quickly and reliably without tools. During the reinstallation, the position of the bracket remains unaltered, and the bracket can thus be used even for mounting high-magnification sighting devices without deterioration of accuracy. In addition, the locking piece remains in the locked position reliably and the locking is clearance-free and strong.

These and other features and advantages of the invention will be more fully understood from the following detailed description of the invention taken together with the accompanying drawings.

### BRIEF DESCRIPTION OF THE DRAWINGS

The appended drawings, illustrate some of the embodiments of the invention, in which:

FIG. 1a is a front view of the support according to the invention,

FIG. 1b is an axonometric view of the support of FIG. 1a,

FIG. 1c is a lateral view of the support of FIG. 1a,

FIG. 1d is a cross-sectional view of the plane B-B of FIG. 1c,

FIG. 2a is an axonometric view of the bracket of the support according to the invention,

FIG. 2b is a lateral view of the bracket of FIG. 2a,

FIG. 2c is a cross-sectional view of the plane A-A of FIG. 2b,

FIG. 3a is an axonometric view of the wedge piece of the support according to the invention,

FIG. 3b is a lateral view of the wedge piece of FIG. 3a,

FIG. 3c is a bottom view of the wedge piece of FIG. 3a,

FIG. 3d is a partial cross-sectional view of the wedge piece of FIG. 3a,

FIG. 4a is a cross-sectional view of a Picatinny™ rail,

FIG. 4b is a lateral view of a part of a Picatinny™ rail,

FIG. 5a is a front view of a second embodiment of the support according to the invention,

FIG. 5b is an axonometric view of the support of FIG. 5a,

FIG. 5c is a lateral view of the support of FIG. 5a,

FIG. 5d is a cross-sectional view of the plane C-C of FIG. 5c,

FIG. 6a shows the support of FIG. 5d in the idle position,

FIG. 6b shows the support of FIG. 5d in the open position,

FIG. 7a is a lateral view of a rotary knob according to the invention,

FIG. 7b is a cross-sectional view of the plane D-D of FIG. 7a,

FIG. 7c is an axonometric view of the rotary knob of FIG. 7a,

FIG. 7d is a modification of the rotary knob according to the invention,

FIG. 8a is a lateral view of a slide according to the invention,

FIG. 8b is a cross-sectional view of the plane E-E of FIG. 8a,

FIG. 8c is a diagonal top view of the slide, and

FIG. 8d is an axonometric view of the slide.

### DETAILED DESCRIPTION OF THE INVENTION

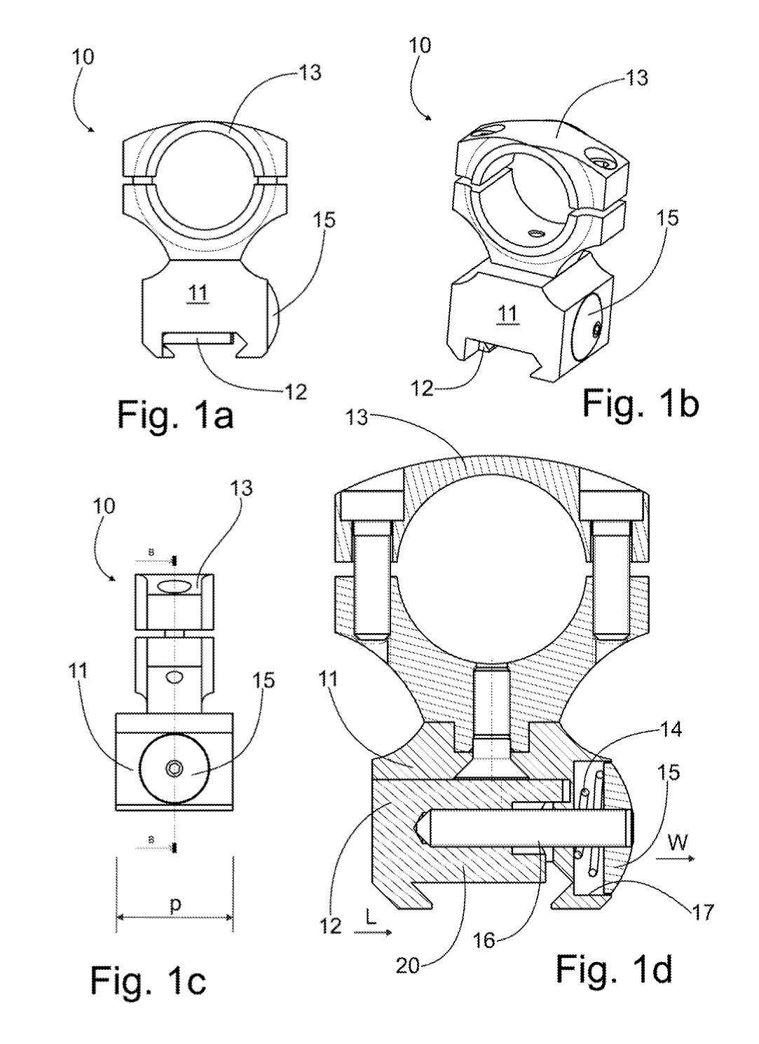

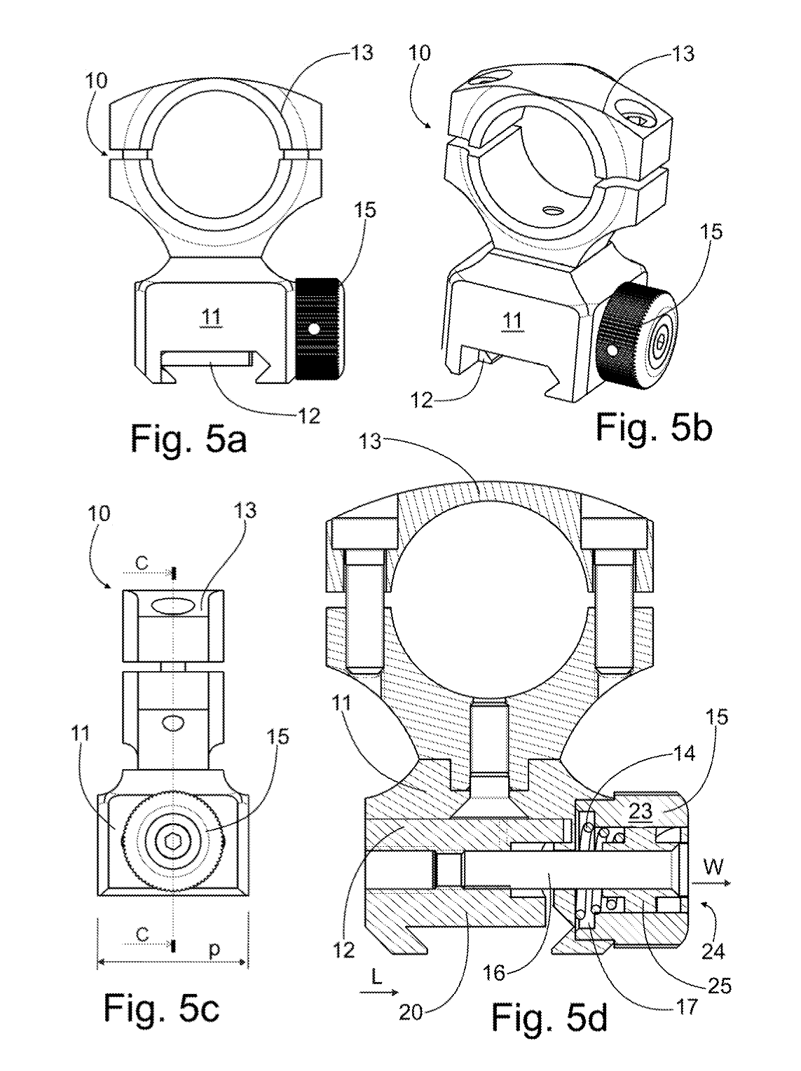

FIGS. 1a to 1d illustrate a support 10 for mounting a sniperscope, for example. Generally, the support can be used to mount almost any accessory to a weapon, more precisely, to a rail arranged in the weapon. The rail may be separately mounted to the weapon or the rail is formed as a part of a breech carrier, for example (not shown). The support 10 includes a bracket 11 and a locking piece 12. In FIGS. 1a to 1d, a ring 13 for a sniperscope is additionally connected to the bracket 11 with a screw. Two supports, more precisely, two separate brackets with rings, are usually needed to mount one sniperscope. Instead of a ring, another accessory can be mounted to the bracket. According to the invention, the support 10 further includes spring elements 14 for forcing the locking piece 12 fitted in the bracket 11 to a locked position. In other words, the support 10 includes spring elements 14, arranged to act on the locking piece 12, the work direction W of said elements being parallel to the locking direction L of the locking piece 12 arranged in the bracket 11 (FIGS. 1d and 5d). Thus, the locking piece always remains clearance-free in the locked position without separate screws or locking latches. The bracket is fastened to the rail with a locking piece manufactured in accordance with the requirements of the shape, utilising spring force.

In the invention, the spring elements 14 are composed of a compression spring. Thus, the spring elements continuously force the locking piece to the locked position, when they are mounted at least in a partly compressed state. In the embodiments proposed, the spring elements 14 are advantageously composed of a conical spring. Mainly based on the spring force required, a wire with a suitable thickness is selected, the number of wire coils in a conical spring being between 3 and 5. Thus, when compressed, the conical compression spring acting on the locking piece in the locking direction advantageously fits even in a space as deep as the diameter of the spring wire. In this way, the dimension referring to the entire width of the bracket can be advantageously minimised.

In the embodiments shown in the figures, a button 15 is arranged as an extension for the locking piece 12 for releasing the locking piece 12 from the locked position. In other words, the button is used to operate the locking piece while simultaneously compressing the conical spring. The same reference numbers are used for functionally identical parts. In the embodiment of FIG. 1d, the button 15 has a disc-like form, which, on one hand, provides sufficient strength and, on the other hand, a short dimension in the width direction of the bracket 11. In other words, the button is low. At the same time, a curved shape is provided on the outer surface of the button without harmful protrusions. The button 15 is connected to the locking piece 12 with a connecting screw 16. However, the use of the locking piece does not require any rotation, simply pressing the button is sufficient. In practice, the locking piece, the connecting screw and the button are connected to each other with locking paste, for example. More precisely, the connecting screw between the locking piece and the button is connected to the locking piece with locking paste. In other words, the connecting screw does not rotate. Due to the screw, fastening is easy and the arrangement can be adjusted, if required. The connecting screw can be replaced with a connecting rod, for example, which is fastened to both the locking piece and the button in some way.

For the button 15, a cavity 17 is arranged in the bracket 11, with a conical spring additionally fitted therein. The construction is extremely simple and the spring force can be adjusted by varying the tension of the connecting screw. In addition, the button is supported to the walls of the cavity and the conical spring is protected from soiling. Replacement of the conical spring is also possible and easy, and the button is mainly located in the cavity. Unlike prior art, screwing is not necessary, simple pressing is sufficient. Furthermore, the locking piece is located on the opposite side of the bracket relative to the button. The necessary movement of the locking piece is a few millimetres, and with the button, the removal and mounting of the bracket only take fractions of a second. In addition, the removal and mounting can be performed without tools. In FIG. 1d, the locking direction of the locking piece 12 is towards right, and the lock is released by pushing the button 13 towards left, i.e. inside the bracket 11. For example, keeping a torch in place is less critical compared to a sniperscope. In any case, the locking piece is continuously pushed to the locked position, or towards right in the embodiment of FIG. 1d, by the spring force. In practice, the button is pressed with one or more fingers, advantageously with a thumb.

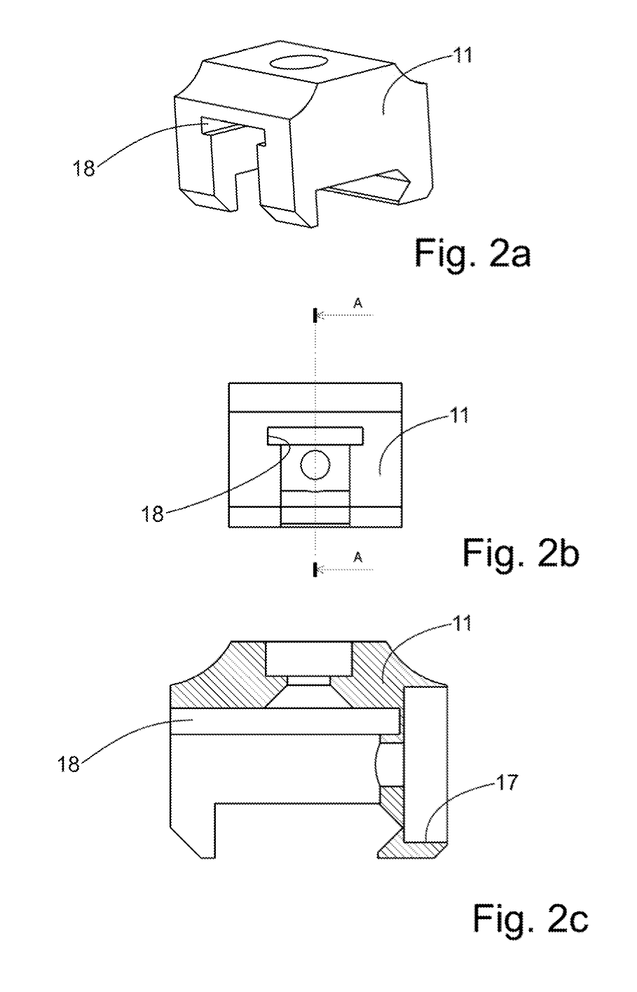

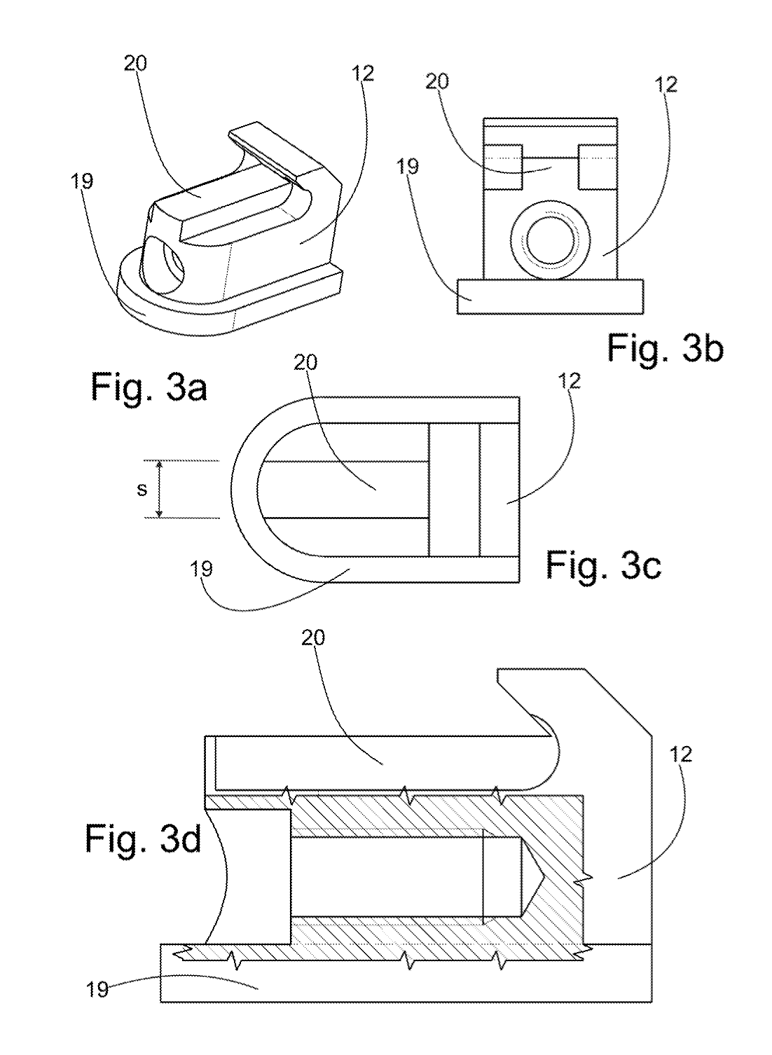

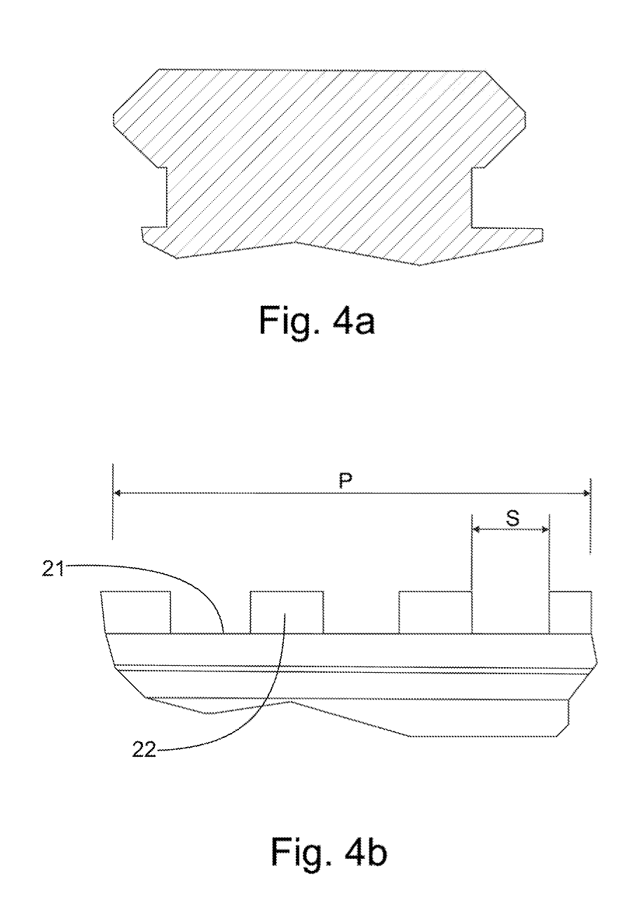

For the locking piece 12, the bracket 11 is provided with a flange-like groove 18 formed by a standard milling tool, for example, in the direction referring to locking L (FIGS. 2a to 2c). Correspondingly, the upper part of the locking piece is circled by a flange-like border 19, the shape of which is enabled by a standard milling tool (FIGS. 3a to 3d). The cross-sectional shape of the locking piece and the border circling the upper part of the locking piece together provide the locking piece with precise control in the locking direction L and as good a support as possible to all directions in conditions where the locking piece locks onto the rail. At the same time, the movement of the connecting screw remains stable, and the connecting screw is also additionally supported to the bracket over a short distance. Thus, the button also remains in the correct position. The locking piece is also supported to the groove provided in the bracket over its entire length. The shape of the locking piece is such that, in the mounting position of the bracket, it is positioned in the transverse groove provided in the Picatinny™ rail functioning in this way as a recoil element in addition to fastening to the rail. In other words, the locking piece 12 includes a recoil counterpart 20, the width s of which is a clearance less than the width S of the groove 21 included in the Picatinny™ rail (FIG. 4b). Without the recoil counterpart, the bracket can be mounted to a Weaver rail or another rail with a similar cross-section, which is not provided with grooves. On the other hand, a transverse groove can be machined in a Weaver rail in a suitable position, in which case a bracket equipped with a recoil counterpart can be used. If necessary, the bracket together with the locking piece are separately dimensioned to suit each rail.

A raw material advantageously suitable to the purpose of use of the support is an aluminium alloy that is suitable to the lightness and strength requirements. Steel is also possible as a raw material at least in some of the components. Anodising, for example, which gives a hard and wear-resistant surface, is suitable particularly as surface finishing of aluminium. Surfaces treated in this way slide against each other moderately well, in which case the effect of friction of increasing the force of pressure is small. If necessary, a lubricant, such as arms oil, is used.

FIGS. 4a to 4b illustrate a Picatinny™ rail, in which necks 22 and grooves 21 follow each other. Thus, the bracket of the support can be mounted to a desired position. Advantageously, the length p of the bracket 11 essentially corresponds to the length P defined by four successive necks 22 included in the Picatinny™ rail. In this case, the bracket is reliably supported to the rail. The shapes and dimensions of the Picatinny™ rail, in particular, are standardised. The shapes and dimensions of other rails are also precisely pre-determined.

FIGS. 5a to 5d illustrate a second embodiment of the support according to the invention. The design and principle of operation of the support correspond to those proposed above. Here, too, a button 15 is connected to a locking piece 12 with a connecting screw 16, which is moveably supported to a bracket 11. Thus, by pressing the button 15, the locking piece 12 can be moved to the open position against the spring force. Here, too, the opening direction is towards left in the figure while the conical spring 14 continuously pushes the locking piece 12 towards right.

In the second embodiment proposed, the button 15 is arranged around the connecting screw 16 as a rotary knob 23 for eliminating the movement of the locking piece 12. The actual opening movement is performed here, too, by pressing the button 15. In addition, the movement of the locking piece can be restricted by rotating the rotary knob. In this way, locking can be secured and inadvertent release can be avoided. In other words, when securing is activated, the button cannot be pressed by any external force. In this way, the locking piece remains in the locked position and thereby, the bracket keeps attached to the rail.

Basically, the functionality described above can be implemented by arranging a rotary knob in the external threads of a connecting screw. Thus, by rotating the rotary knob, the clearance between the rotary knob and the bracket can be removed, thus preventing the movement of the button and thereby, of the locking piece as well. Thus, locking of the locking piece is secured. Depending on the pitch of thread, realising the securing action requires rotating the screw several turns, which may be too slow for release and mounting operations that must be performed quickly.

To speed up the securing action, the bracket 12 includes a limiter 24 extending to the rotary knob 23, which is arranged to allow the movement of the locking piece 12 in one position of the rotary knob 23 while restricting the movement of the locking piece 12 in a position deviating from this position.

In this case, the securing effect of the rotary knob depends on the position of the rotary knob instead of the number of turns. In other words, the securing effect is provided by rotating the knob clearly less than one turn.

In the second embodiment, the limiter 24 is arranged as a slide 25 fitted inside the rotary knob 23 and connected to the locking piece 12. More precisely, the slide 25 is unrotably fastened to the locking piece 12 with a connecting screw 16. Thus, these three components move linearly as one package, which is loaded by a conical spring fitted between the slide 25 and the bracket 11. Here, too, the package continuously tends to move towards right keeping the mounting of the bracket unaltered and clearance-free. The functionality of the slide 25 is realised with the rotary knob 23. Here, the rotary knob has a cylindrical inner bore 26, according to which the slide 25 is dimensioned. Thus, the contact between the slide and the rotary knob set within each other is clearance-free while allowing at the same time mutual twisting and axial offset of the slide and the rotary knob. In addition, the slide 25 has a guide groove 27, with a corresponding cylindrical pin 28 in the rotary knob 23. Thus, the guide groove determines the mutual position of the slide and the rotary knob.

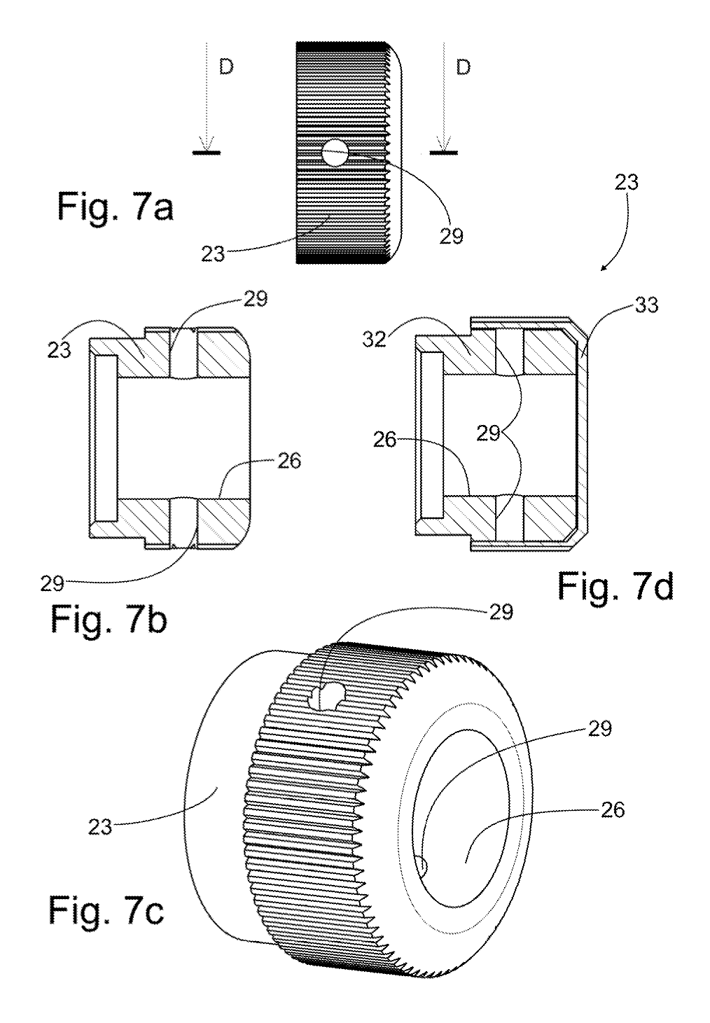

FIGS. 7a to 7d illustrate the rotary knob 23. Two holes 29 are opposing each other for cylindrical pins. In this way, the rotary knob and the slide are uniformly loaded. Basically, only one cylindrical pin and guide groove are sufficient, or even three cylindrical pins may be provided. Installation of the cylindrical pin is secured with locking paste. The cylindrical pin can be replaced with a threaded rod. In this case, the knob has a radially extending threaded hole.

FIG. 7d illustrates a modification of the rotary knob 23. Here the rotary knob 23 has two parts. The frame of the rotary knob 32 is almost similar to that of the rotary knob of FIG. 7b except that it has a smooth surface without a straight knurl. A closed shell 33 for the rotary knob is placed on the frame of the rotary knob 32 and fastened with a fixing agent. Thus, the frame 32 and the shell 33 of the rotary knob form one entity. As the shell is continuous, there are no visible grooves or counterbores in the rotary knob. In addition, the shell protects the parts and sliding surfaces located inside the rotary knob from solid impurities and splashes of water. Cylindrical pins also remain in place without locking paste, because they are kept inside the shell of the rotary knob. In addition, the shell can only be removed with a hot air blower or similar.

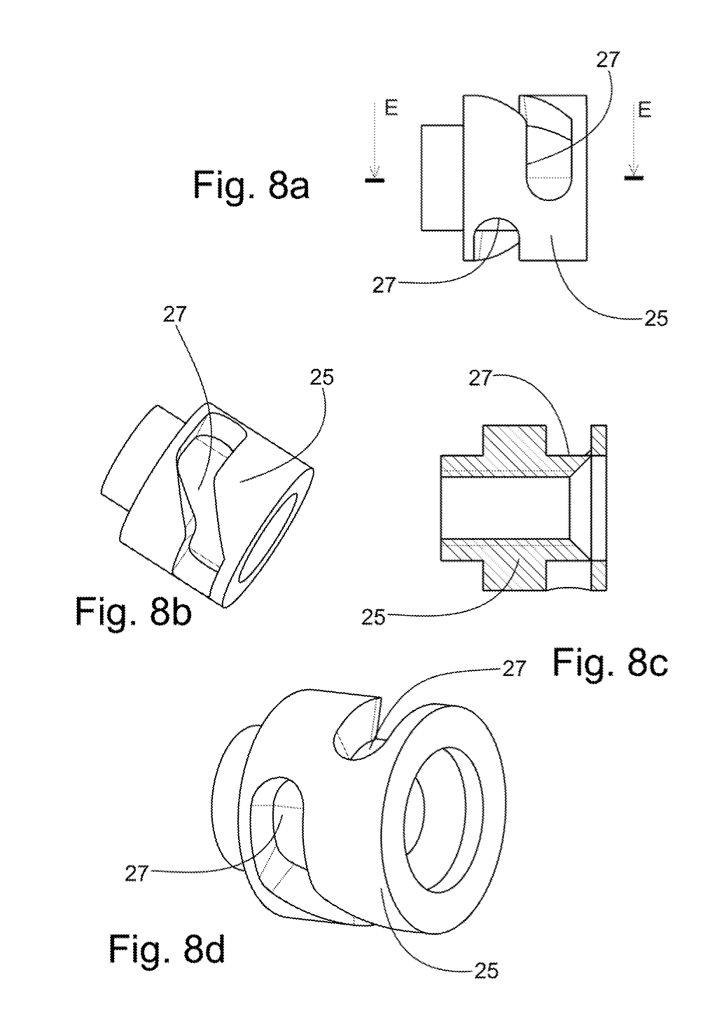

FIGS. 8a to 8d illustrate the slide 25. Here, two similar guide grooves 27 are provided and they are positioned on the opposite sides of the slide periphery. In addition, the guide groove has a parallel offset. In other words, the different ends of the grooves end at different positions in the longitudinal direction of the slide. Thus, by rotating the rotary knob, the mutual axial position of the rotary knob and the slide changes. Here, extensions are provided in the transverse direction of the slide at both ends of the guide groove, at which extensions the mutual position of the slide and the rotary knob does not change. A change only takes place in the rising section of the guide groove.

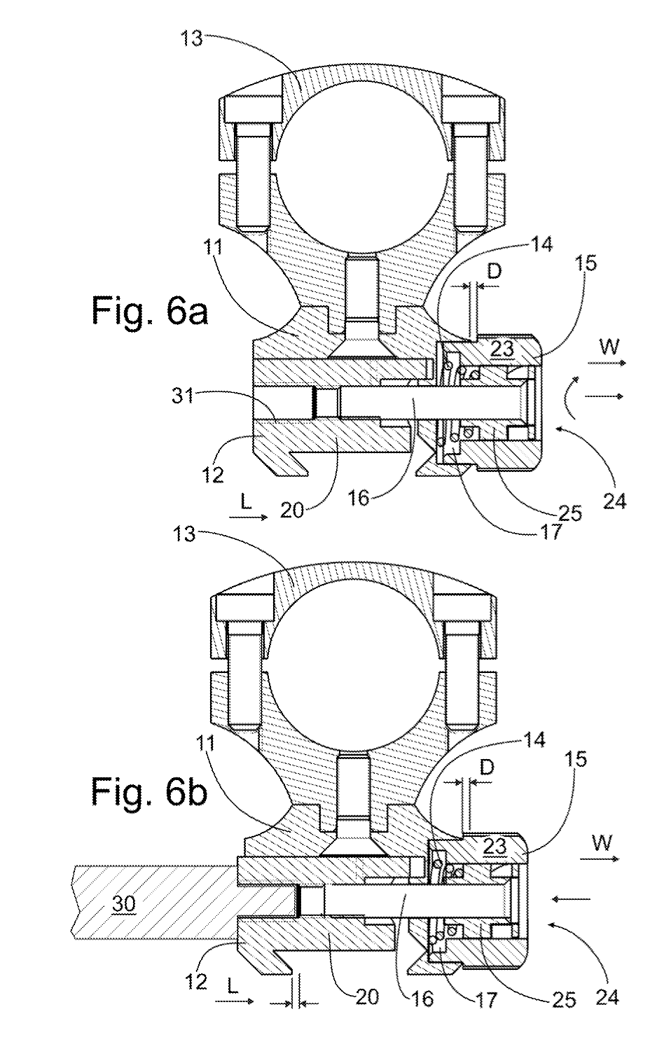

In the condition of FIG. 5d, locking of the locking piece is secured. Here, the rotary knob 23 butts on the bracket 11 by its end and shoulder. Thus, since it is impossible for the button to move anywhere, locking is secure. The condition of FIG. 6a is otherwise similar except that here the securing action has been removed. To remove it, it is sufficient to slightly rotate the rotary knob 23, here counterclockwise. Due to the slide and its guide groove, the rotary knob moves axially a few millimetres outwards when being rotated. Thus, a clearance D is created between the rotary knob and the bracket, which enables pressing the button and thus moving the locking piece to the open position (FIG. 6b). After remounting the bracket, locking is secured by rotating the rotary knob slightly clockwise. The rising angle of rotation of the guide groove 27 in the slide 25 of FIG. 8c is approximately 45 degrees and, in addition, the angle of each of the end parts of the guide groove is approximately 10 degrees. Thus, the maximum angle of rotation of the rotary knob is approximately 65 degrees, i.e. only less than a sixth of a turn.

Advantageously, all components are machined with one tool mounting. In this way, the accuracy of dimensions and shape is ensured and thus, the bracket and the mounting foot will always be in the same position, regardless of repeated releasing and mounting operations. Thus, aiming a weapon equipped with a sniperscope, for example, is not necessary after removing and mounting a sighting device.

The assembly and use of the support is described below. The support is immediately ready for use after the manufacturer's assembly. When reassembling various components after maintenance, adjustments or repair by the user, the components are carefully cleaned to remove any impurities. The locking piece is slid to the bracket, and the slide together with the rotary knob and then the conical spring are placed in the connecting screw. The rotary knob is turned to the secured position, in which the ends of the slide and the rotary knob are flush (FIG. 5d). After this, the connecting screw is turned to such an extent that the shoulder of the rotary knob butts on the bracket. At the same time, the rotary knob butts on the bottom of the cavity in the example shown. Locking paste is used in the connecting screw so that various components are unrotating except for the rotary knob, which turns around the slide. When turning the rotary knob to the open position, the clearance mentioned above is created, allowing pushing the button and thus moving the locking piece so that the removal and mounting of the bracket is possible. In the embodiment proposed, the clearance is 3.5 mm; however, a movement as small as two millimetres enables removal of the bracket. Thus, a practical clearance is between 2 and 4 mm.

The bracket is mounted as follows: The bracket is placed on the rail tilting the bracket to the side of the button. Next, it is explored when the recoil counterpart of the locking piece arrives at the corresponding groove of the rail. Then the button is pressed down and the bracket is turned to the horizontal position. Finally, when releasing the button, the bracket is fastened in place. The securing action is provided by turning the rotary knob clockwise until resistance is felt. The bracket is removed as follows: The rotary knob is turned counterclockwise to the open position. The button is pressed down while simultaneously tilting the bracket to the side of the button, at which the support is released from the rail. Two supports of a sighting device are used simultaneously according to the instructions given above. Two hands are used, if necessary.

Various accessories can be mounted to the bracket with screws. FIG. 6b illustrates an accessory 30, which is mounted to the locking piece 12. For this, the locking piece is provided with a threaded hole 31. This increases possibilities of mounting accessories and improves the usability of the bracket.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

What is claimed is:

1. Support for mounting an accessory to a weapon, the support including a bracket and a locking piece fitted in the bracket, characterized in that the support further includes spring elements, arranged to act on the locking piece, the work direction (W) of said elements being parallel to the locking direction (L) of the locking piece fitted in the bracket.

2. Support according to claim 1, characterized in that the spring elements are composed of a compression spring.

3. Support according to claim 2, characterized in that the spring element is composed of a conical spring.

4. Support according to claim 3, characterized in that the number of wire coils of the conical spring is between 3 and 5.

5. Support according to claim 1, characterized in that a button is arranged as an extension for the locking piece for releasing the locking piece from a locked position.

6. Support according to claim 5, characterized in that the spring elements are arranged between the bracket and the button.

7. Support according to claim 5, characterized in that a cavity is arranged in the bracket for the button.

8. Support according to claim 5, characterized in that the button is connected to the locking piece with a connecting screw, which is movably supported to the bracket.

9. Support according to claim 8, characterized in that the button is arranged around the connecting screw as a rotary knob for eliminating the movement of the locking piece.

10. Support according to claim 9, characterized in that the bracket includes a limiter, which extends to the rotary knob and is arranged to allow the movement of the locking piece in one position of the rotary knob while restricting movement of the locking piece in a position deviating from this position.

11. Support according to claim 10, characterized in that the limiter is arranged as a slide fitted inside the rotary knob and connected to the locking piece.

12. Support according to claim 1, characterized in that the locking piece includes a recoil counterpart, the width (s) of which is a clearance less than the width (S) of the groove included in a Picatinny™ rail.

13. Support according to claim 1, characterized in that the length (p) of the bracket essentially corresponds to the distance (P) defined by four successive necks included in a Picatinny™ rail.
